(19) United States
(12) Patent Application Publication
(10) Pub. No.: US 2019/0377945 A1
(43) Pub. Date: Dec. 12, 2019

(54) SYSTEM, METHOD, AND PROGRAM FOR DETECTING ABNORMALITY

(71) Applicant: OPTiM Corporation, Saga-shi (JP)

(72) Inventor: Shunji SUGAYA, Tokyo (JP)

(21) Appl. No.: 15/749,839

(22) PCT Filed: Feb. 28, 2017
(86) PCT No.: PCT/JP2017/007804

§ 371 Date: Feb. 2, 2018

(51) Int. Cl. G06K 9/00; G06T 7/90; G05D 1/00; B64C 39/02; G06T 7/174

(52) U.S. Cl. CPC G06K 9/00657; G06T 7/90; G05D 1/0011; G06T 2207/30188; G06T 7/174; B64C 2201/123; B64C 2201/146; B64C 39/024

(57) ABSTRACT

A system for detecting an abnormality of the present invention includes an airborne imaging device and a controller. The control unit of the airborne imaging device performs the imaging module to collectively image a plurality of objects to be analyzed that are distributed in a constant large area from the sky. Then, the control unit performs the abnormality detection module to detect an abnormality of some of the objects to be analyzed in the constant large area based on a first image over a large area that has been taken by the imaging module from the sky. Subsequently, the control unit performs the imaging module again to focus and image around the object to be analyzed in which an abnormality was detected by the abnormality detection unit, from the sky.

### TECHNICAL FIELD

The present invention relates to a system, a method, and a program for detecting an abnormality.

### BACKGROUND ART

Laver has been widely cultivated in the sea. While laver is cultivated, the red rot disease can be developed because viruses infest laver to cause rust colored spots, resulting in the cut fronds of laver. To cultivate laver, the protection for laver from the red rot disease is a major issue.

To improve the efficiency of the disease protection for laver, it is proposed that, for example, the liquid obtained by electrolysis of the seawater solution containing an organic acid with an acid dissociation constant of 4 or more is sprayed by using a shower, a nozzle, etc. from above over and down below laver nets (for example, refer to Patent Document 1).

### CITATION LIST

### Patent Literature

Patent Document 1: JP 2006-151925A SUMMARY OF INVENTION

Even though laver is attempted to be protected from disease but affected by disease, the affected part should be promptly made known and quickly and appropriately treated to prevent the spread of the disease. However, as shown in FIG. 8, the scale of the cultivation of laver spread with a large area with tens of thousands of square meters. Thus, it takes a lot of effort to promptly and surely know the affected part.

To reduce the effort, the laver cultivation area may be imaged from the sky to know the presence or absence of disease based on the image. However, to accurately know the presence or absence of disease, the laver cultivation area should be imaged from a low attitude, e.g., from 2 to 3 meters high. It is difficult or inefficient to image the entire laver cultivation area from a low attitude in the consumption of the battery, the processing performance of the controller, and the image capacity of the memory of an air vehicle. Especially, if the power from the installed battery is consumed and lacked, the air vehicle will be crashed and damaged. Therefore, the technology to reduce the consumption of the battery, the processing performance of the controller, and the image capacity of the memory of an air vehicle and quickly and accurately know the presence or absence of disease over the entire laver cultivation area.

In view of such demand, an objective of the present invention is to provide a system that is capable to quickly and accurately know an abnormality found in some of a large number of objects to be analyzed that are distributed in a constant large area.

The first aspect of the present invention provides a system for detecting an abnormality, including:

a wide-angle imaging unit that collectively images a plurality of objects to be analyzed that are distributed in a constant large area;

an abnormality detection unit that detects an abnormality of some of the objects to be analyzed in the constant large area based on a first image taken by the wide-angle imaging unit; and

a detail imaging unit that focuses and images around the object to be analyzed in which an abnormality was detected by the abnormality detection unit.

According to the first aspect of the present invention, the wide-angle imaging unit collectively images a plurality of objects to be analyzed that are distributed in a constant large area; the abnormality detection unit detects an abnormality of some of the objects to be analyzed in the constant large area imaged by the wide-angle imaging unit based on a first image taken by the wide-angle imaging unit; and the detail imaging unit focuses and images around the object to be analyzed in which an abnormality was detected by the abnormality detection unit.

Accordingly, the wide-angle imaging unit performs the primary screening an object to be analyzed so that the consumption of the battery, the processing performance of the controller, and the image capacity of the memory of the system for detecting an abnormality can be reduced more compared with the case of strictly checking the presence or absence of abnormality in all the objects to be analyzed. Then, the detail imaging unit focuses and images around the object to be analyzed in which an abnormality was detected by the abnormality detection unit. Accordingly, the secondary screening can be performed on the object to be analyzed so that a misjudgment that an abnormality is present regardless of the absence of abnormality can be prevented.

Therefore, the first aspect of the present invention can provide the system that is capable to reduce the consumption of the battery, the processing performance of the controller, and the image capacity of the memory of the system for detecting an abnormality and quickly and accurately know the abnormality if there is an abnormality in some of a large number of areas to be analyzed that are distributed in a constant large area.

The second aspect of the present invention provides the system according to the first aspect of the present invention, further including: an abnormality analysis unit that analyzes the object to be analyzed in which an abnormality was detected by the abnormality detection unit based on a second image taken by the detail imaging unit.

According to the second aspect of the present invention, the abnormality analysis unit performs the second screening on the object to be analyzed so that a misjudgment that an abnormality is present regardless of the absence of abnormality can be prevented.

The third aspect of the present invention provides the system according to the first or the second aspect of the present invention, in which the object to be analyzed is laver cultivated in the sea, the abnormality detection unit detects that the color of a part of laver in the constant large area is different from that of normal laver based on the first image, and the detail imaging unit focuses and images around the laver, the color of which is different from that of normal laver, if the abnormality detection unit detects that the color of a part of laver is different from that of normal laver.

According to the third aspect of the present invention, the wide-angle imaging unit performs the primary screening on laver cultivated in a large area in the sea so that the consumption of the battery, the processing performance of the controller, and the image capacity of the memory of the system for detecting an abnormality can be reduced more compared with the case of strictly checking the difference in the color of all the laver cultivated in a large area. Then, the detail imaging unit focuses and images around the laver, the color of which is different from that of normal laver, if the abnormality detection unit detects that the color of a part of laver is different from that of normal laver. Accordingly, the secondary screening can be performed on abnormal laver so that a misjudgment that an abnormality is present regardless of the absence of abnormality can be prevented.

Therefore, the third aspect of the present invention can provide the system that is capable to reduce the consumption of the battery, the processing performance of the controller, and the image capacity of the memory of the system for detecting an abnormality and quickly and accurately know the abnormality if the color of a part of laver is different from that of normal laver, in a large amount of laver cultivated in a constant large area.

The present invention can provide a system that is capable to quickly and accurately know an abnormality found in some of a large number of areas to be analyzed that are distributed in a constant large area.

### BRIEF DESCRIPTION OF DRAWINGS

FIG. 1 shows a block diagram illustrating a hardware configuration and a software function of the system for detecting an abnormality 1 in an embodiment.

FIG. 2 shows a flow chart illustrating how to detect an abnormality in the embodiment.

FIG. 3 shows an example of the image to be displayed on the image display unit 25 of the controller 3 to set a condition for wide-angle imaging.

FIG. 4 shows a schematic pattern diagram to explain the pixels of an image which the camera 80 takes.

FIG. 5 shows a schematic pattern diagram to explain the imaging accuracy when the camera 80 provided in the airborne imaging device 2 takes an image from the sky.

FIG. 6 shows an example of the image to be displayed on the image display unit 25 of the controller 3 to show the condition for wide-angle imaging.

FIG. 7 shows a block diagram illustrating a hardware configuration and a software function of the system for detecting an abnormality 1′ in a variation.

FIG. 8 shows a pattern diagram illustrating that laver is cultivated on a large scale.

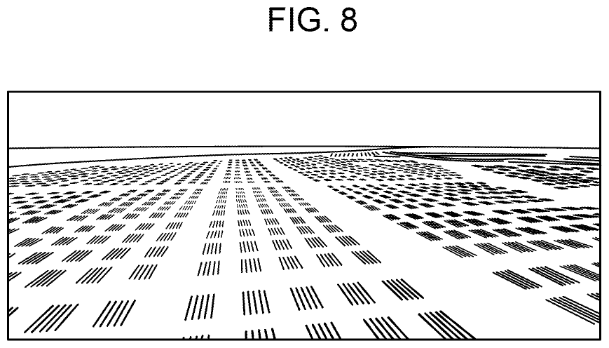

### DESCRIPTION OF EMBODIMENTS

Embodiments of the present invention will be described below with reference to the attached drawings. However, this is illustrative only, and the technological scope of the present invention is not limited thereto.

### Configuration of System for Detecting an Abnormality 1

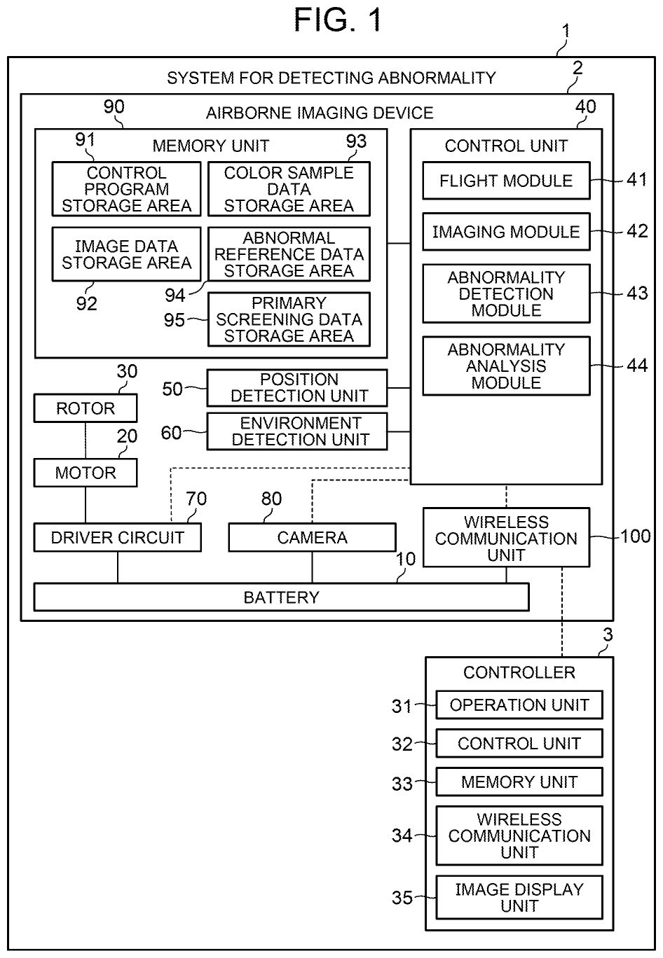

FIG. 1 shows a block diagram illustrating a hardware configuration and a software function of the system for detecting an abnormality 1 in an embodiment.

The system for detecting an abnormality 1 includes an airborne imaging device 2 that is capable to image a plurality of objects to be analyzed that are distributed in a constant large area and a controller 3 that is connected with this airborne imaging device 2 through wireless communication to control the airborne imaging device 2.

The plurality of objects to be analyzed are not limited in particular as long as they are distributed in a constant large area and can be analyzed to check the presence or absence of abnormality occurring in a specific point. Examples of the objects to be analyzed include (1) laver cultivated over an area with tens of thousands of square meters in the sea, which can be analyzed through the image to check the presence or absence of disease including the red rot disease caused in a specific point, (2) crops cultivated in a field with several hectares or more, which can be analyzed through the image to check the presence or absence of disease and insect damage caused in a specific point, (3) livestock raised on an area above a certain level, which can be analyzed through the image to check the presence or absence of infection disease such as bird flu that is originated in a specific point, and (4) objects which can be analyzed through the image to check the presence or absence of property damages such as car accidents caused in a specific point in an area above a certain level. For convenience, the object to be analyzed is cultivated laver, and the system for detecting an abnormality 1 checks the presence or absence of the red rot disease of the cultivated laver in the following description.

### Airborne Imaging Device 2

The airborne imaging device 2 is not limited in particular as long as it is capable to image a plurality of objects distributed in a constant large area from the sky. For example, the airborne imaging device 2 may be a radio control airplane or an unmanned air vehicle that is called a drone. In the following description, the airborne imaging device 2 is a drone.

The airborne imaging device 2 includes a battery 10 that functions as a power supply to the airborne imaging device 2, a motor 20 that works on electric power supplied from the battery 10, and a rotor 30 that rotates by the motor 20 to float and fly the airborne imaging device 2.

The airborne imaging device 2 also includes a control unit 40 that controls the operation of the airborne imaging device 2, a position detection unit 50 that provides position information on the airborne imaging device 2 to the control unit 40, an environment detection unit 60 that provides environment information on the weather, the illumination, etc., to the control unit 40, a driver circuit 70 that drives the motor 20 by control signals from the control unit 40, a camera 80 that images an object to be analyzed from the sky by control signals from the control unit 40, and a memory unit 90 that previously stores control programs, etc., executed by the microcomputer of the control unit 40 and stores images taken by the camera 80.

The airborne imaging device 2 also includes a wireless communication unit 100 that communicates with the controller 3 over the wireless.

These components are installed in the structure of the main body (e.g., frame) with a predetermined shape. For the structure of the main body (e.g., frame) with a predetermined shape, the one similar to a known drone only has to be used.

### Battery 10

The battery 10 is a primary cell or a secondary cell, which supplies electric power to the components in the airborne imaging device 2. The battery 10 may be fixed to the airborne imaging device 20 or detachable.

### Motor 20 and Rotor 30

The motor 20 functions as the driving source to rotate the rotor 30 by electric power supplied from the battery 10. Rotating the rotor 30 can float and fly the airborne imaging device 2.

### Control Unit 40

The control unit 40 includes a CPU (Central Processing Unit), a RAM (Random Access Memory), and a ROM (Read Only Memory).

The control unit 40 reads a predetermined program to achieve a flight module 41, an imaging module 42, an abnormality detection module 43, and an abnormality analysis module 44.

The control unit 40 controls the motor 20 in cooperation with the flight module 41 to control the flight (e.g., ascent, descent, and horizontal motion) of the airborne imaging device 2. The control unit 40 also controls the motor 20 by using the gyro (not shown) installed in the airborne imaging device 2 to control the attitude of the airborne imaging device 2.

### Position Detection Unit 50

The position detection unit 50 is not limited in particular as long as it is capable to detect the latitude, the longitude, and the altitude of the airborne imaging device 2. For example, the position detection unit 50 includes a GPS (Global Positioning System).

### Environment Detection Unit 60

The environment detection unit 60 is not limited in particular as long as it is capable to detect environment information on the weather, the illumination, etc., that affects imaging an object to be analyzed. For example, the altitude of the airborne imaging device 2 should be reduced in the rain more than that in the sunshine. Therefore, the weather is environment information that affects the imaging of an object to be analyzed. Examples of the device to detect the weather include a humidity sensor. Alternatively, the weather information may be acquired from a predetermined web site providing weather information through the wireless communication unit 100.

Moreover, since the illumination in the morning, evening, etc., is smaller than that in the daytime, the altitude of the airborne imaging device 2 should be reduced in the morning, evening, etc. Therefore, the illumination is environment information that affects the imaging of an object to be analyzed. Examples of the device to detect the illumination include an illumination sensor.

### Driver Circuit 70

The driver circuit 70 has a function to apply a voltage specified from a control signal from the control unit 40 to the motor 20. This enables the driver circuit 70 to drive the motor 20 by control signals from the control unit 40.

### Camera 80

The camera 80 has a function to convert (take) an optical image taken from the lens into image signals with the imaging element such as CCD or CMOS. The type of the camera 80 is chosen according to the technique to check the abnormality of an object to be analyzed through the image. For example, to check the red rot disease of cultivated laver because an optical camera is suitable as the camera 80, the presence or absence of the red rot disease of cultivated laver is checked based on the color of an object to be analyzed (visible light). For example, to check the abnormality of an object to be analyzed through the image based on the heat quantity of the object, an infrared camera is suitable as the camera 80. For example, to check the abnormality of an object to be analyzed through the image in the night, a night-vision camera is suitable as the camera 80.

The camera 80 may take a still or moving image. However, the camera 80 preferably takes a moving image because even a beginner can image everything in the whole area (laver cultivation area in this embodiment) where a plurality of objects to be analyzed are distributed.

The still image can be preferable because it has a smaller capacity of imaging data than the moving image. However, in this embodiment, the altitude when the airborne imaging device 2 takes an image is increased as much as possible, and the capacity of imaging data is decreased as much as possible. Therefore, the present invention can keep the consumption of the battery, the processing performance of the controller, and the image capacity of the memory of the airborne imaging device 2 low even if the image taken by the camera 80 is a moving image. In the respect, even a moving image taken by the camera 80 can be suitably used in this embodiment.

In this embodiment, the image taken by the camera 80 is a moving image.

To set a higher altitude of the airborne imaging device 2, the view angle of the camera 80 is preferably as large as possible. In this embodiment, the camera 80 is a general-purpose camera, which has a view angle of 90 degrees for convenience of explanation.

To set a higher altitude of the airborne imaging device 2, the resolution of an image is preferably as large as possible. For example, a 2K image has 1920 horizontal×1080 vertical pixels. For example, a 4K image has 3840 horizontal×2160 vertical pixels. For example, an 8K image has 7680 horizontal×4320 vertical pixels. In this embodiment, the image is a 4K image with a resolution of 3840 horizontal×2160 vertical pixels.

### Memory Unit 90

The memory unit 90 is to store data and files and includes a data storage unit such as a hard disk, a semiconductor memory, a record medium, or a memory card. The memory unit 90 has a control program storage area 91 to previously store control programs, etc., executed by the microcomputer of the control unit 40 and an image data storage area 92 that stores images taken by the camera 80 together with location data (including the latitude, the longitude, and the altitude of the point where the images were taken) detected by the position detection unit 50. The memory unit 90 also has a color sample data storage area 93 that previously stores color sample data, an abnormal reference data storage area 94 that previously stores image data indicating one example where an object to be analyzed is abnormal, and a primary screening data storage area 95 that primarily stores information on an object to be analyzed that is temporarily judged as abnormal based on an image taken from a comparatively high altitude.

The color sample data are not limited in particular. Examples of the color sample data include gradation data indicating colors mixed in 10% color density intervals by colors (e.g., C, M, Y, and K).

### Wireless Communication Unit 100

The wireless communication unit 100 is configured to be capable of wireless communication with the controller 3 to receive remote control signals from the controller 3.

### Controller 3

The controller 3 has the function to control the airborne imaging device 2. The controller 3 includes an operation unit 31 that is used, for example, when the user controls the airborne imaging device 2, a control unit 32 that controls the operation of the controller 3, a memory unit 33 that previously stores control programs, etc., executed by the microcomputer of the control unit 32, a wireless communication unit 34 that communicates with the airborne imaging device 2 over the wireless, and an image display unit 35 that displays a predetermined image to the user.

The wireless communication unit 34 is configured to be capable of wireless communication with the airborne imaging device 2 to receive remote control signals from the airborne imaging device 2.

The wireless communication unit 34 may include a device, such as a Wireless Fidelity (Wi-Fi®) enabled device complying with, for example, IEEE 802.11 that is capable to access a predetermined web site that provides weather information or map information.

The image display unit 35 may be integrated with or separated from an operating device that controls the airborne imaging device 2. The image display unit 35 integrated with an operating device can decrease the number of devices that the user uses and increase the convenience. Examples of the image display unit 35 separated from an operating device include mobile terminal devices such as a smart phone and a tablet terminal that are capable of wireless connection with the communication unit 100 of the airborne imaging device 2. The image display unit 35 separated from an operating device has the advantage of applicability in existing operating devices that do not have an image display unit 35.

### Flow Chart Illustrating How to Detect an Abnormality by Using the System for Detecting an Abnormality 1

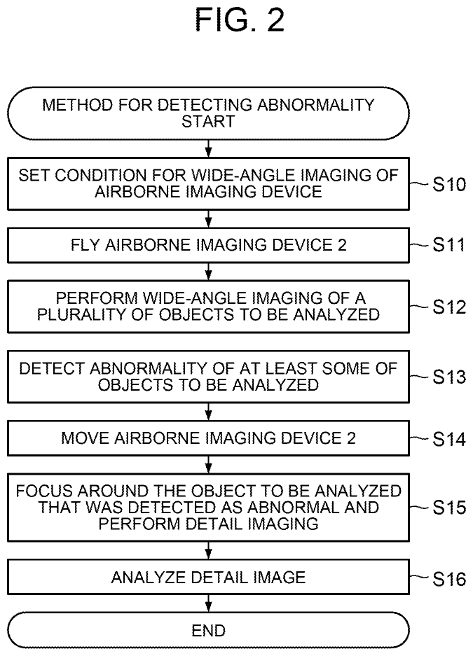

FIG. 2 shows a flow chart illustrating how to detect an abnormality by using the system for detecting an abnormality 1. The tasks executed by the modules of the above-mentioned hardware and software will be described below.

### Step S10: Set Condition for Wide-Angle Imaging of Airborne Imaging Device 2

Although not required, the condition for wide-angle imaging is preferably set to collectively image a plurality of objects to be analyzed that are distributed in a constant large area.

When taking an image from the sky, the airborne imaging device 2 should be able to recognize an object to be analyzed (imaged) by analyzing the image of the sea surface. If the airborne imaging device 2 cannot recognize it, an abnormality of some of the objects to be analyzed in the constant large area cannot be detected based on the image even though the camera 80 collectively images a plurality of objects to be analyzed that are distributed in a constant large area (e.g., a number of laver cultivation areas distributed over an area with tens of thousands of square meters in the sea).

On the other hand, if the altitude of the airborne imaging device 2 is too low, the number of images that requires to image the entire laver cultivation area from a low altitude is too many. This leads to a large amount of burden the battery, the controller, and the memory provided in the air vehicle.

Thus, the altitude of the airborne imaging device 2 to collectively image a plurality of objects to be analyzed that are distributed in a constant large area is preferably set as high as possible to the extent that the airborne imaging device 2 is able to recognize an object to be analyzed (imaged) by analyzing the image of the sea surface. Furthermore, the altitude of the airborne imaging device 2 can preferably be automatically calculated in this case.

To set the condition for wide-angle imaging, the control unit 32 of the controller 3 performs the wide-angle imaging condition set module (not shown) to instruct the image display unit 25 to select and display the image from the image data stored in the memory unit 33.

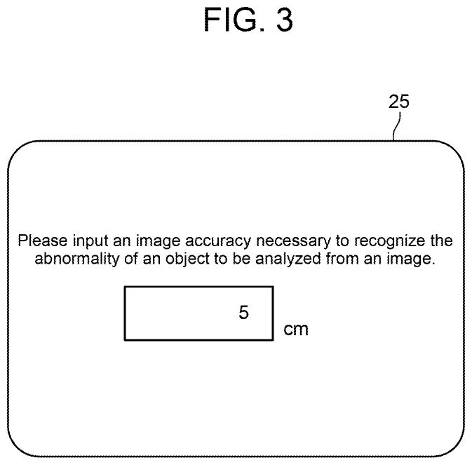

FIG. 3 shows one example of the display screen displayed on the image display unit 25 to set the condition for wide-angle imaging. The upper part of the display screen shows “Please input an image accuracy necessary to recognize the abnormality of an object to be analyzed from an image.” The user inputs “5 cm” as the image accuracy necessary to recognize the abnormality of an object to be analyzed (the red rot disease of cultivated laver in this embodiment) from an image through the operation unit 31.

The control unit 32 transmits information input from the user to the airborne imaging device 2 through the wireless communication unit 34.

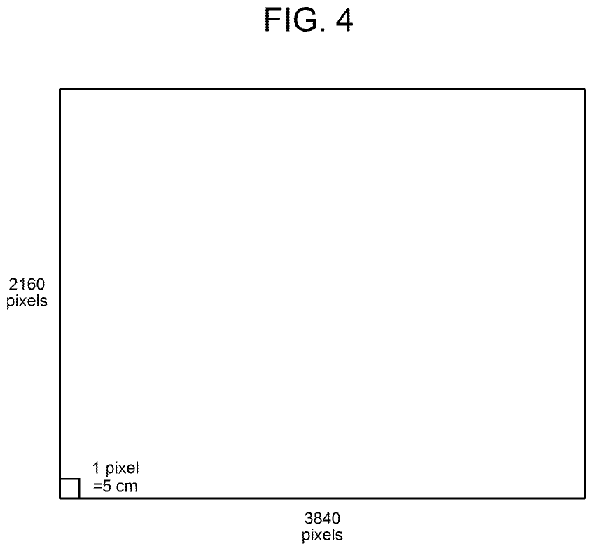

FIG. 4 shows a schematic pattern diagram to explain an image which the camera 80 takes. In this embodiment, the image is a 4K image with a resolution of 3840 horizontal×2160 vertical pixels. Since “5 cm” was input as the image accuracy (size per pixel) in the display screen shown in FIG. 3, the imaging range of one image has a width of 5 cm×3840 pixels=192 m and a length of 5 cm×2160 pixels=108 m.

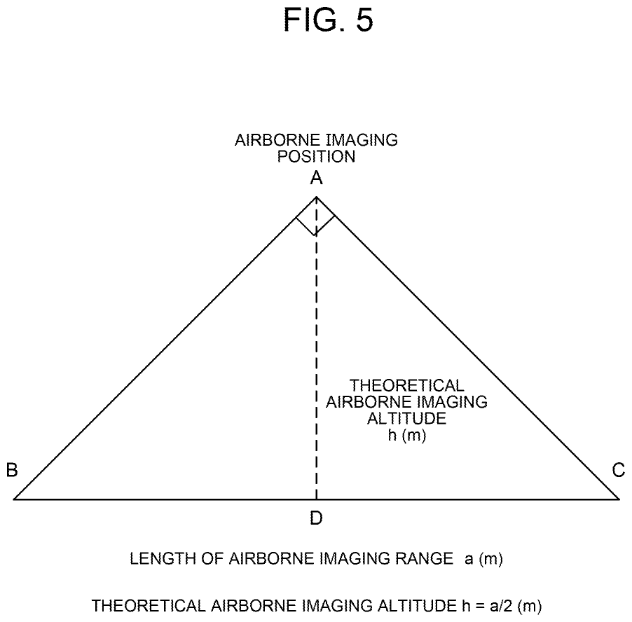

FIG. 5 shows a pattern diagram illustrating the airborne imaging range of the airborne imaging device 2 located at the point A with an altitude of h (m). In this embodiment, since the view angle of the camera 80 is 90 degrees, the triangle ABC is homothetic to the triangle DAB, and the homothetic ratio is 2:1. Then, the theoretical airborne imaging altitude h (m) is a half of the length (long side) of the airborne imaging range (of one image) that is defined as a (m).

The control unit 40 of the airborne imaging device 2 performs the flight module 41 to set the image accuracy i (cm)×0.01×3840 pixels×0.5=19.2×i (m) that has been transmitted from the controller 3 as the theoretical airborne imaging altitude. In this embodiment, since the necessary image accuracy was set to “5 cm,” the theoretical airborne imaging altitude is 96 m.

The imaging altitude of the airborne imaging device 2 is affected by environment information on the weather, the illumination, etc. For example, the altitude of the airborne imaging device 2 is preferably reduced in the rain more than that in the sunshine. Moreover, since the illumination in the morning, evening, etc., is smaller than that in the daytime, the altitude of the airborne imaging device 2 is preferably reduced in the morning, evening, etc.

Accordingly, the control unit 40 preferably adjusts the actual airborne imaging altitude based on the detection result from the environment detection unit 60.

The adjusted airborne imaging altitude is transmitted to the controller 3 through the wireless communication unit 100.

The control unit 32 of the controller 3 calculates the imaging area of one photograph based on the adjusted airborne imaging altitude that has been transmitted from the airborne imaging device 2. As explained in FIG. 5, the length (long side) of the airborne imaging range (of one image) that is defined as a (m) is twice the airborne imaging altitude h (m). The length of the short side of the airborne imaging range of one image is 9/16 times that of the long side.

The control unit 32 of the controller 3 instructs the image display unit 35 to display the adjusted airborne imaging altitude and the imaging area of one image.

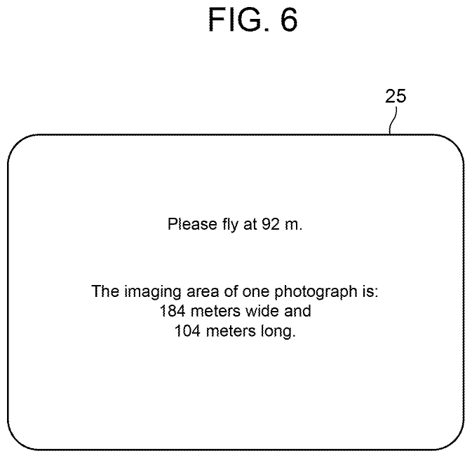

FIG. 6 shows one example of the display screen on the image display unit 35. The upper part of the display screen shows “Please fly at 92 m.” This clarifies that the altitude of the airborne imaging device 2 only has to be adjusted to 92 m as the condition for collectively imaging a plurality of objects to be analyzed that are distributed in a constant large area

The lower part of the display screen shows “The imaging area of one photograph is 184 meters wide and 104 meters long.” This clarifies that the area recognized from one photograph is 184 meters wide and 104 meters long.

### Step S11: Fly Airborne Imaging Device 2

The user operates the operation unit 31 of the controller 3, following the instruction shown in FIG. 6. The operation information is transmitted from the control unit 32 to the airborne imaging device 2 through the wireless communication unit 34.

The control unit 40 of the airborne imaging device 2 performs the flight module 41 to control the motor 20 to control the flight (e.g., ascent, descent, and horizontal motion) of the airborne imaging device 2. Moreover, the control unit 40 controls the motor 20 by using the gyro (not shown) installed in the airborne imaging device 2 to control the attitude of the airborne imaging device 2.

Although not required, the control unit 40 preferably transmits information to re-adjust the actual airborne imaging altitude to the controller 3 through the wireless communication unit 100 according to the change in the detection result from the environment detection unit 60.

If the flight altitude is higher than the set altitude, the control unit 40 preferably transmits information indicating that the flight altitude is higher than the set altitude to the controller 3 through the wireless communication unit 100. Accordingly, the controller 3 can display “The altitude exceeds 92 m now. So the abnormality of an object to be analyzed might not be recognizable accurately. Please decrease the altitude.,” for example.

### Step S12: Perform Wide-Angle Imaging of a Plurality of Objects to be Analyzed

The control unit 40 of the airborne imaging device 2 performs the imaging module 42 to instruct the camera 80 to take an image.

The airborne imaging device 2 flies, following the instruction shown in FIG. 6. The image taken by the camera 80 corresponds to an image of a plurality of objects distributed in a large area with a width of 184 meters and a length of 104 meters, which are collectively taken at an altitude of 92 m in the area.

The image is stored in the image data storage area 93 of the memory unit 90 together with the location data (data on the altitude, the longitude, and the altitude of the point where the image was taken) detected by the position detection unit 50 when the camera 80 took the image.

### Step S13: Detect Abnormality of at Least Some of Objects to be Analyzed

The control unit 40 of the airborne imaging device 2 performs the abnormality detection module 43 to detect the abnormality of an object to be analyzed that exists in the area in the first image taken in the step S12.

The technique to detect abnormality is not limited in particular. One example of the technique will be described below.

### Preliminary Setting

First, the preliminary setting is performed before the abnormality detection described in this embodiment.

The control unit 40 reads out image data indicating one example where an object to be analyzed is abnormal that are stored in the abnormal reference data storage area 94 of the memory unit 90. Then, the control unit 40 refers to the color sample data stored in the color sample data storage area 93 to derive a color tone corresponding that of an abnormal object to be analyzed. Subsequently, the control unit 40 transmits the data on the color tone corresponding that of an abnormal object to be analyzed to the controller 3 through the wireless communication unit 100.

The control unit 32 of the controller 3 displays the color tone corresponding that of an abnormal object to be analyzed on the image display unit 35. The user sets a threshold to check whether or not an object to be analyzed is abnormal based on this color tone.

In this embodiment, the primary screening in wide-angle imaging and the secondary screening in detail imaging are performed. Since the detection of abnormality in the step S13 corresponds to the primary screening, the threshold is preferably set intensely, specifically, to prevent misjudgment that an abnormality is present regardless of the absence of abnormality.

In this embodiment, an example is the red rot disease of cultivated laver. In this case, even if the color is slightly lighter than that corresponding to the red rot disease, if the color contains red or purple, the threshold is preferably set to detect an abnormality.

The information on the set threshold is transmitted from the controller 3 to the airborne imaging device 2 and set in the abnormal reference data storage area 94.

### Detect Abnormality

After the step S13, the control unit 40 of the airborne imaging device 2 performs the abnormality detection module 43.

In this embodiment, the image is a 4K image, which can be divided into 3840 horizontal×2160 vertical pixels. These 8.29 million areas each have any one of three primary colors (red, green, and blue) with independent brightness information. Each of 8.29 million areas is compared with the threshold to detect abnormality that was set in the preliminary setting. The pixel (area) that exceeds the threshold is determined as an area containing an object to be analyzed with potential abnormality. On the other hand, the pixel (area) that does not exceed the threshold is determined as an area not containing an object to be analyzed with potential abnormality.

Then, the location information of the pixel (area) that exceeds the threshold is set in the primary screening data storage area 95. The type of the location information is not limited in particular. Examples of the location information include coordinate information derived from data on the wide-angle image taken in the step S12.

### Step S14: Move Airborne Imaging Device 2

The control unit 40 of the airborne imaging device 2 performs the flight module 41 to move the airborne imaging device 2.

First, the control unit 40 of the airborne imaging device 2 reads out the location information on the pixel (area) set in the primary screening data storage area 95 (coordinate information derived from data on the wide-angle image taken in the step S12).

Then, the control unit 40 of the airborne imaging device 2 reads out data on the wide-angle image taken in the step S12 from the image data storage area 92 and derives the geographic data (latitude and longitude information) of the pixel (area) set in the primary screening data storage area 95 from the location data (data on the altitude, the longitude, and the altitude of the point where the image was taken) detected by the position detection unit 50 when the camera 80 took the image.

Then, the control unit 40 of the airborne imaging device 2 transmits the geographic data (latitude and longitude information) to the controller 3 through the wireless communication unit 100. The controller 3 displays information on the received geographic data (latitude and longitude information) on the image display unit 35.

The user follows the display on the image display unit 35 to move the airborne imaging device 2 to the predetermined latitude and longitude and lower the altitude of the airborne imaging device 2.

In this embodiment, an example is to know the red rot disease of laver. To accurately know the presence or absence of disease, the laver cultivation area should be imaged from a low attitude, e.g., from 2 to 3 meters high. In this embodiment, the altitude of the airborne imaging device 2 is lowered to from 2 to 3 m.

### Step S15: Focus Around the Object to be Analyzed That was Detected as Abnormal and Perform Detail Imaging

The control unit 40 of the airborne imaging device 2 performs the imaging module 42 to instruct the camera 80 to take an image.

The airborne imaging device 2 flies at the position in the step S14. Thus, the image taken by the camera 80 corresponds to that focusing around the object to be analyzed that was detected as abnormal.

The image is stored in the image data storage area 93 of the memory unit 90 together with the location data (data on the altitude, the longitude, and the altitude of the point where the image was taken) detected by the position detection unit 50 when the camera 80 took the image.

### Step S16: Analyze Detail Image

The control unit 40 of the airborne imaging device 2 performs the abnormality analysis module 44 to analyze the object that was detected as abnormal in the step S13 based on the second image taken in the step S15.

The analysis technique is not limited in particular. For example, an existing recognition system may be used to read out data on the second image taken in the step S15 and image data indicating one example where an object to be analyzed is abnormal that are stored in the abnormal reference data storage area 94 and determine the closeness of agreement between the both data.

Alternatively, the control unit 40 of the airborne imaging device 2 may transmit data on the second image taken in the step S15 to the controller 3 through the wireless communication unit 100 to allow the user to visually check the data displayed on the image display unit 35 of the controller 3. These analysis techniques can be used together.

### Operation and Working-Effect of the Present Invention

According to the present invention described in this embodiment, the control unit 40 of the airborne imaging device 2 performs the imaging module 42 to collectively image a plurality of objects to be analyzed that are distributed in a constant large area. Then, the control unit 40 performs the abnormality detection module 43 to detect an abnormality of some of the objects to be analyzed in the constant large area based on a first image over a large area that has been taken by the operation of the imaging module 42. Subsequently, the control unit 40 performs the imaging module 42 again to focus and image around the object to be analyzed in which an abnormality was detected by the abnormality detection unit.

Accordingly, the primary screening an object to be analyzed is performed so that the consumption of the battery 10, the processing performance of the control unit 40, and the image capacity of the memory unit 90 of the airborne imaging device 2 can be reduced more compared with the case of strictly checking the presence or absence of abnormality in all the objects to be analyzed. Then, the imaging module 42 is performed again to focus and image around the object to be analyzed in which an abnormality was detected by the operation of the abnormality detection module 43. Accordingly, the secondary screening can be performed on the object to be analyzed so that a misjudgment that an abnormality is present regardless of the absence of abnormality can be prevented.

Therefore, the present invention described in this embodiment can provide the system for detecting an abnormality 1 that is capable to reduce the consumption of the battery 10, the processing performance of the control unit 40, and the image capacity of the memory unit 90 of the airborne imaging device 2 and quickly and accurately know the abnormality if there is an abnormality in some of a large number of areas to be analyzed that are distributed in a constant large area.

Moreover, according to the present invention described in this embodiment, the control unit 40 performs the abnormality analysis module 44 to analyze the object to be analyzed in which an abnormality was detected by the operation of the abnormality detection module 43 based on a second image taken by the second operation of the imaging module 42.

According to the present invention, the second screening is performed on the object to be analyzed so that a misjudgment that an abnormality is present regardless of the absence of abnormality can be prevented.

### Variations

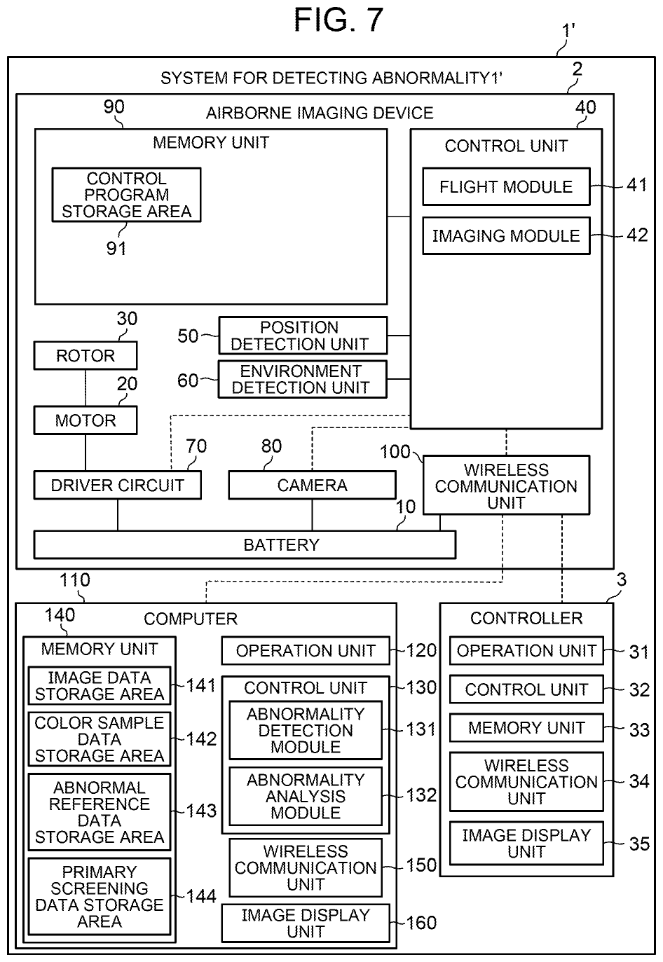

FIG. 7 schematically shows the configuration of the system for detecting an abnormality 1′ according to a variation of the system for detecting an abnormality 1 described in this embodiment.

The same reference signs as those shown in FIG. 1 have the same configurations corresponding to those of the system for detecting an abnormality 1 described in this embodiment.

The system for detecting an abnormality 1′ of this variation is different from the system for detecting an abnormality 1 in that the system for detecting an abnormality 1′ further includes a computer 110 in addition to the components of the system for detecting an abnormality 1 to relocate the functions of the abnormality detection module 43 and the abnormality analysis module 44 that are performed by the control unit 40 of the airborne imaging device 2 to the computer 110. This enables the computer 110 to function like a cloud device. Therefore, the system for detecting an abnormality 1′ can more reduce the consumption of the battery 10, the processing performance of the control unit 40, and the image capacity of the memory unit 90 of the airborne imaging device 2.

The components of the computer 110 are expressed in the same way as those of the system for detecting an abnormality 1 of this embodiment. The components have the same functions corresponding to those described in the system for detecting an abnormality 1 of this embodiment.

To achieve the means and the functions that are described above, a computer (including a CPU, an information processor, and various terminals) reads and executes a predetermined program. For example, the program is provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

### REFERENCE SIGNS LIST

1 System for detecting an abnormality
10 Battery
20 Motor
30 Rotor
40 Control unit
41 Flight module
42 Imaging module
43 Abnormality detection module
44 Abnormality analysis module
50 Position detection unit
60 Environment detection unit
70 Driver circuit
80 Camera
90 Memory unit
91 Control program storage area
92 Image data storage area
93 Color sample data storage area
94 Abnormal reference data storage area
95 Primary screening data storage area
100 Wireless communication unit

1. A system for detecting an abnormality, comprising:
a wide-angle imaging unit that collectively images a plurality of objects to be analyzed that are distributed in a constant large area;
an abnormality detection unit that detects an abnormality of some of the objects to be analyzed in the constant large area based on a first image taken by the wide-angle imaging unit; and
a detail imaging unit that focuses and images around the object to be analyzed in which an abnormality was detected by the abnormality detection unit,
wherein the object to be analyzed is laver cultivated in the sea,
the abnormality detection unit detects that the color of a part of laver in the constant large area is different from that of normal laver based on the first image, and
the detail imaging unit focuses and images around the laver, the color of which is different from that of normal laver, when the abnormality detection unit detects that the color of a part of laver is different from that of normal laver.

2. The system according to claim 1, further comprising an abnormality analysis unit that analyzes the object to be analyzed in which an abnormality was detected by the abnormality detection unit based on a second image taken by the detail imaging unit.

3. (canceled)

4. A system for detecting an abnormality, comprising:
an airborne imaging device; and a computer that is communicatively connected with the airborne imaging device, wherein
the airborne imaging device has:
a wide-angle imaging unit that collectively images a plurality of objects to be analyzed that are distributed in a constant large area; and
a detail imaging unit that focuses and images an area smaller than the area that can be imaged by the wide-angle imaging unit, and
the computer has:
an abnormality detection unit that detects an abnormality of some of the objects to be analyzed in the constant large area based on a first image taken by the wide-angle imaging unit; and
a switch instruction unit that instructs an unmanned air vehicle to switch from the wide-angle imaging unit to the detail imaging unit to take an image if the abnormality detection unit detects an abnormality,
wherein the object to be analyzed is laver cultivated in the sea,
the abnormality detection unit detects that the color of a part of laver in the constant large area is different from that of normal laver based on the first image, and
the detail imaging unit focuses and images around the laver, the color of which is different from that of normal laver, when the abnormality detection unit detects that the color of a part of laver is different from that of normal laver.

5. The system according to claim 4, wherein the computer further has an abnormality analysis unit that analyzes the object to be analyzed in which an abnormality was detected by the abnormality detection unit based on a second image taken by the detail imaging unit.

6. A method for detecting an abnormality, comprising the steps of:
collectively imaging a plurality of objects to be analyzed that are distributed in a constant large area;
detecting an abnormality of some of the objects to be analyzed in the constant large area based on a first image taken by the wide-angle imaging unit; and
focusing and imaging around the object to be analyzed in which an abnormality was detected by the abnormality detection unit,
wherein the object to be analyzed is laver cultivated in the sea,
detecting the abnormality includes detecting that the color of a part of laver in the constant large area is different from that of normal laver based on the first image, and
focusing and imaging around the object to be analyzed includes focusing and imaging around the laver, the color of which is different from that of normal laver, when detecting that the color of a part of laver is different from that of normal laver.

7. A computer program product for use in a system for detecting an abnormality, comprising a non-transitory computer usable medium having a set of instructions physically embodied therein, the set of instructions including computer readable program code, which when executed by the system causes a processor to execute the steps of:
collectively imaging a plurality of objects to be analyzed that are distributed in a constant large area;
detecting an abnormality of some of the objects to be analyzed in the constant large area based on a first image taken by the wide-angle imaging unit; and
focusing and imaging around the object to be analyzed in which an abnormality was detected by the abnormality detection unit,.
wherein the object to be analyzed is laver cultivated in the sea,
detecting the abnormality includes detecting that the color of a part of laver in the constant large area is different from that of normal laver based on the first image, and
focusing and imaging around the object to be analyzed includes focusing and imaging around the laver, the color of which is different from that of normal laver, when detecting that the color of a part of laver is different from that of normal laver.
